(19) United States
(12) Patent Application Publication
(10) Pub. No.: US 2007/0289100 A1
(43) Pub. Date: Dec. 20, 2007

(54) Casement Window Hinge

(75) Inventors: Rodney R. Lake, Machesney Park, IL (US); Mitchell D. Gilbert, South Beloit, IL (US); Julie Kathleen Earp, Rockford, IL (US); George E. Heid, Rockford, IL (US); Abanni B. Maxwell, Rockford, IL (US)

Correspondence Address: BANNER & WITCOFF, LTD., TEN SOUTH WACKER DRIVE, SUITE 3000, CHICAGO, IL, 60606, US

(73) Assignee: Newell Operating Company, Atlanta, GA (US)

(21) Appl. No.: 11/763,086

(22) Filed: Jun. 14, 2007

Related U.S. Application Data
(60) Provisional application No. 60/813,964, filed on Jun. 14, 2006.

(51) Int. Cl. E05D 15/00

(52) U.S. Cl. 16/362

(57) ABSTRACT

A hinge assembly is suitable for use with a casement window assembly. The hinge assembly includes a frame fixedly connected to the window frame, a track on the hinge frame including a channel, a shoe slidably connected to the track, a sash arm pivotably connected to the shoe and fixedly connected to the window, and a swivel arm pivotably connected at a first end to the sash arm and pivotably connected at a second end to the hinge frame. The hinge assembly also includes structure for limiting pivoting of the sash arm relative to the shoe. The hinge assembly further includes means disposed on the hinge frame for assisting insertion of a portion of the shoe into the channel to mount the shoe on the track. An adjustment mechanism, having an eccentric adjuster and a quick-connect structure, pivotably connects the swivel arm to the frame.

### CROSS-REFERENCE TO RELATED APPLICATIONS

The present application is a continuation-in-part of and claims the benefit of U.S. Provisional Patent Application No. 60/813,964, which application is incorporated by reference herein and made a part hereof.

### FEDERALLY SPONSORED RESEARCH OR DEVELOPMENT

None.

### TECHNICAL FIELD

The invention relates to casement windows, and more specifically, to a hinge assembly for a casement window assembly.

### BACKGROUND OF THE INVENTION

Casement window assemblies are known in the art and typically have a sash window pivotally mounted in a window frame by a hinge assembly. Certain hinge designs may have adjustment mechanisms as well as cooperative sliding structures to provide smooth operation of the casement window. While casement window assemblies and hinge assemblies of the prior art provide a number of advantageous features, they nevertheless have certain limitations.

The present invention is provided to solve problems associated with casement window assemblies, and to provide advantages and aspects not provided by prior casement windows and hinge assemblies. A full discussion of the features and advantages of the present invention is deferred to the following detailed description, which proceeds with reference to the accompanying drawings.

### SUMMARY OF THE INVENTION

Aspects of the present invention provide a hinge assembly for a casement window assembly, including a hinge frame adapted to be mounted on the window frame, the hinge frame having a track comprising an elongated channel. A shoe is slidably mounted on the track such that a portion of the shoe is received in the channel. A sash arm is pivotably coupled at one end to the shoe and adapted to be attached to the window. Means are disposed on the hinge frame for assisting insertion of the portion of the shoe into the channel to mount the shoe on the track. According to one aspect, the means for assisting insertion of the portion of the shoe into the channel is an embossed guide on the hinge frame adjacent an end of the channel. According to another aspect, the means for assisting insertion of the portion of the shoe into the channel is a flared portion on an end of the channel, the flared portion having a width greater than a width of the channel along a majority of the length thereof. According to a further aspect, the hinge assembly may have means for limiting a range of pivoting of the sash arm with respect to the shoe.

Aspects of the present invention also provide a hinge assembly for a casement window assembly that includes a hinge frame adapted to be mounted on the window frame and a hinge arm pivotably coupled at a first end to the hinge frame and adapted to be operatively coupled at a second end to the window. The first end of the hinge arm has a slot proximate a tip thereof and an aperture spaced from the slot. A mounting structure pivotably couples the hinge arm to the hinge frame and includes a spring member pivotably coupled to the hinge frame, a pin connected to the spring member, an adjuster rotatably coupled to the resilient spring member. The pin is received in the slot of the hinge arm, and the adjuster is coupled to the hinge arm such that a projection of the adjuster is received within the aperture of the hinge arm. Rotation of the adjuster changes the position of the projection with respect to the pin, thereby changing the position of the hinge arm with respect to the pin. The hinge arm is connectable to and disconnectable from the mounting structure by flexing the spring member to move the projection of the adjuster out of position to be received within the aperture of the hinge arm.

Further aspects of the invention provide an adjustment mechanism for a casement window assembly having a hinge assembly. The adjustment mechanism includes an eccentric adjuster and a retaining member adapted to be mounted on the hinge assembly. The adjuster includes a base having a plurality of points on the outer surface and a projection adapted to be pivotably connected to one of the arms of the hinge assembly, such that rotation of the adjuster moves the connection point of the arm. The retaining member has a notch therein. The retaining member is moveable between a first position, where the retaining member engages the base of the adjuster to prevent rotation of the adjuster such that one of the points is received in the notch, and a second position, where the retaining member does not engage the base of the adjuster to prevent rotation of the adjuster.

Still further aspects of the invention provide a snap-on connection assembly for components of a casement window assembly, including first and second members of the casement window assembly, each having a first aperture therein. The connection assembly further includes a rivet connected to the first member through the aperture, and a flexible, resilient bushing disposed around the rivet. The bushing has a flange and a tapered portion adjacent the flange. The second member is pivotably connected to the first member by inserting the rivet and the bushing into the second aperture. When an inner surface of the second aperture contacts the tapered portion the bushing flexes inwardly to permit the second member to pass the flange. When the second member passes the flange, the bushing flexes outwardly. The outwardly-flexed flange has a width that is greater than a width of the second aperture, and thus, the second member is secured to the bushing to form the pivotable connection.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a casement window assembly in a closed position;

FIG. 1A is a perspective view of the casement window assembly of FIG. 1 in an open position;

FIG. 1B is a rear perspective view of the casement window assembly of FIG. 1 in the open position;

FIG. 2 is a perspective view of a hinge assembly of for a casement window assembly in a closed position;

FIG. 3 is an exploded perspective view of the hinge assembly of FIG. 2;

FIG. 4 is a focused perspective view of a portion of the hinge assembly of FIG. 2 in an open position;

FIG. 5 is a focused perspective view of a shoe, a rivet, and a sash arm of the hinge assembly of FIG. 2;

FIG. 6 is an end view of a frame and a shoe of the hinge assembly of FIG. 2;

FIG. 7 is a focused exploded perspective view of a portion of the hinge assembly of FIG. 2;

FIG. 8 is a focused side view of a portion of the hinge assembly of FIG. 2;

FIG. 9 is a perspective view of an adjuster of the hinge assembly of FIG. 2;

FIG. 10 is a perspective view of an adjustment mechanism of the hinge assembly of FIG. 2;

FIG. 11 is a top view of a second embodiment of a hinge assembly for a casement window assembly in the closed position;

FIG. 12 is a top view of the hinge assembly of FIG. 11 in the open position;

FIG. 13 is a perspective view of the hinge assembly of FIG. 11 in the open position;

FIG. 14 is a perspective view of a portion of the hinge assembly of FIG. 11;

FIG. 15 is an end view of a frame and a shoe of the hinge assembly of FIG. 11;

FIG. 16 is a perspective view of an adjuster of the hinge assembly of FIG. 11;

FIG. 17 is a side view of the adjuster of FIG. 16;

FIG. 18 is a perspective view of a third embodiment of a hinge assembly for a casement window assembly in the open position;

FIG. 18A is a perspective view of an adjustment mechanism of the hinge assembly of FIG. 18;

FIG. 19 is a focused perspective view of a portion of a fourth embodiment of a hinge assembly for a casement window assembly in the open position;

FIG. 20 is a focused plan view of an alternate embodiment of an adjustment mechanism for a hinge assembly;

FIG. 21 is a perspective view of a portion of a fifth embodiment of a hinge assembly for a casement window assembly in the open position;

FIG. 22 is an exploded view of a connection assembly for a casement window assembly;

FIG. 23 is a bottom perspective view of the connection assembly of FIG. 22;

FIG. 24 is a perspective view of the connection assembly of FIG. 22; and,

FIG. 25 is a perspective view of a rivet of the connection assembly of FIG. 22.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

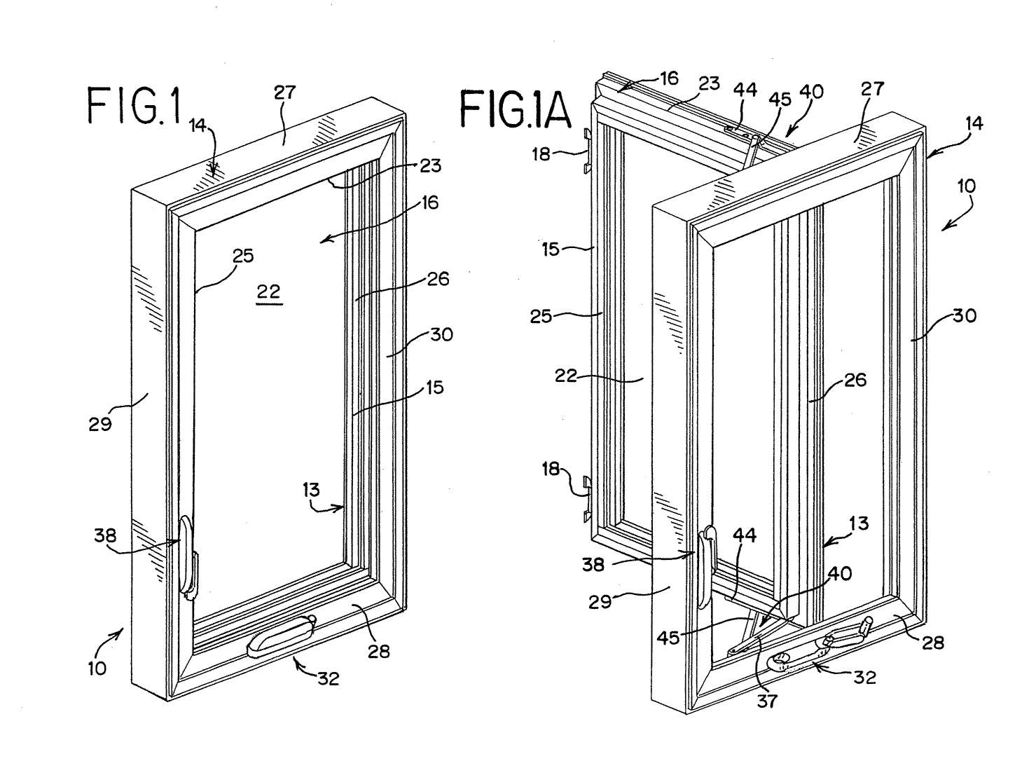

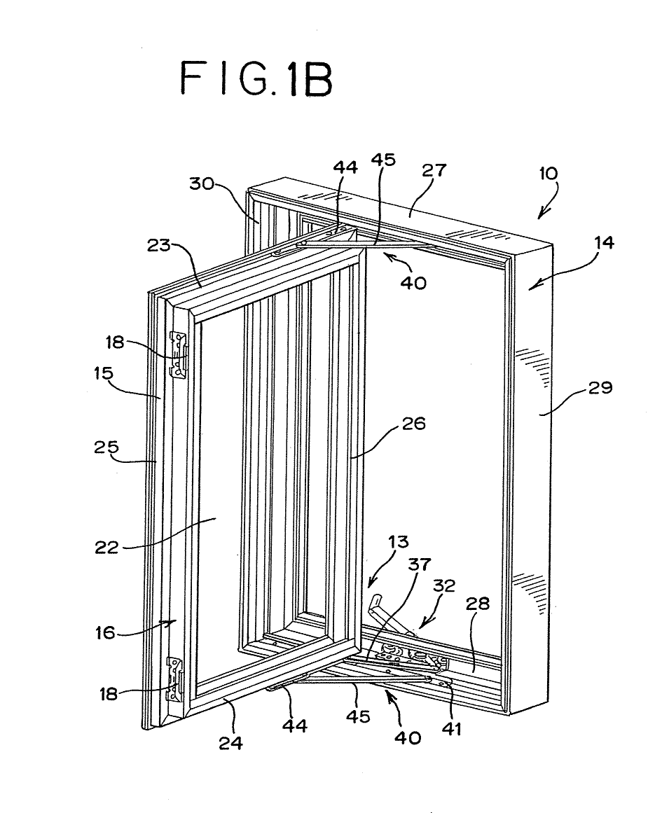

FIGS. 1-1B show a casement window assembly 10, which includes a jamb frame assembly or window frame 14, and an inner window assembly or window 16. The inner window assembly 16 is formed of a sash frame 15 bordering a window pane 22. The sash frame 15 is formed by two vertical rails 25,26 and two horizontal rails 23,24. The window frame 14 is formed by two vertical jambs 29,30 and two horizontal jambs 27,28. The window 16 and window frame 14 are secured by hinged connections 13, such that the window 16 is moveable between an open and closed configuration relative the frame 14 by pivotal movement of the window 16. FIG. 1 depicts the window assembly 10 with the window 16 pivoted into the closed configuration relative the frame 14. FIGS. 1A and 1B depict the window assembly 10 with the window 16 pivoted into the open configuration relative to the frame 14. The window 16 is moved by an operator assembly 32 that includes an actuator (not shown), a housing (not shown) mounted on the bottom jamb 28, and one or more movable operating arms 37 that move back and forth by cranking the actuator 34 to move the window 16. The hinged connection 13 includes a hinge assembly 40 that pivotably supports the window 16. Two locking mechanisms 38 are positioned on one of the vertical jambs 29 and the adjacent vertical rail 25 to secure the jamb 29 to the rail 25, locking the window assembly 10 shut. Two keepers 18 are positioned on the vertical rail 29 adjacent the locking mechanisms 38 for this purpose.

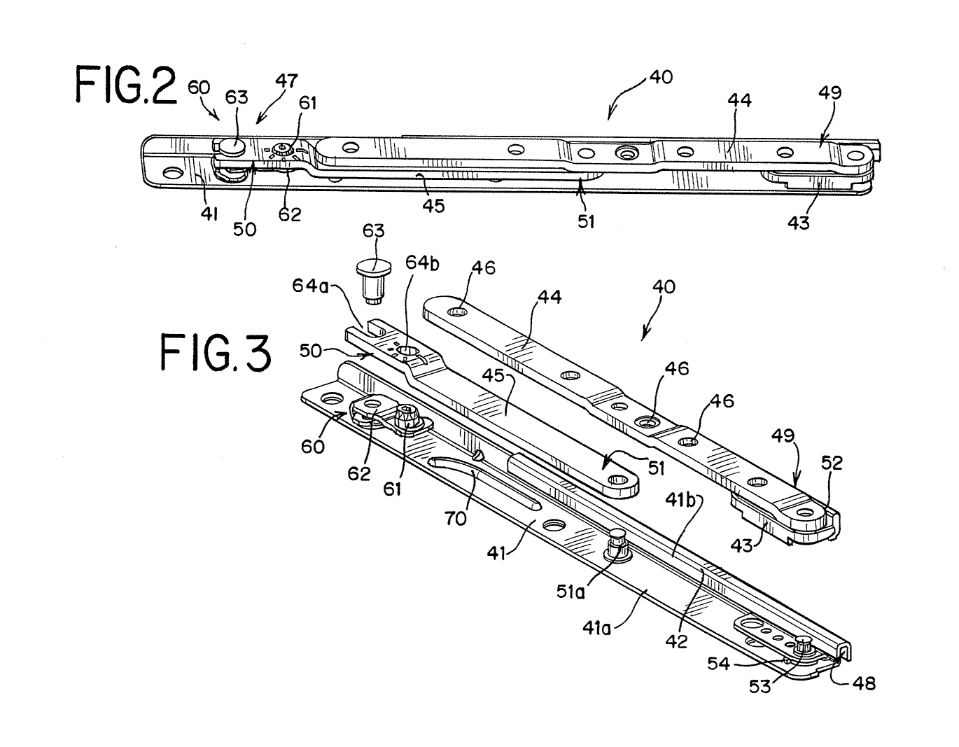

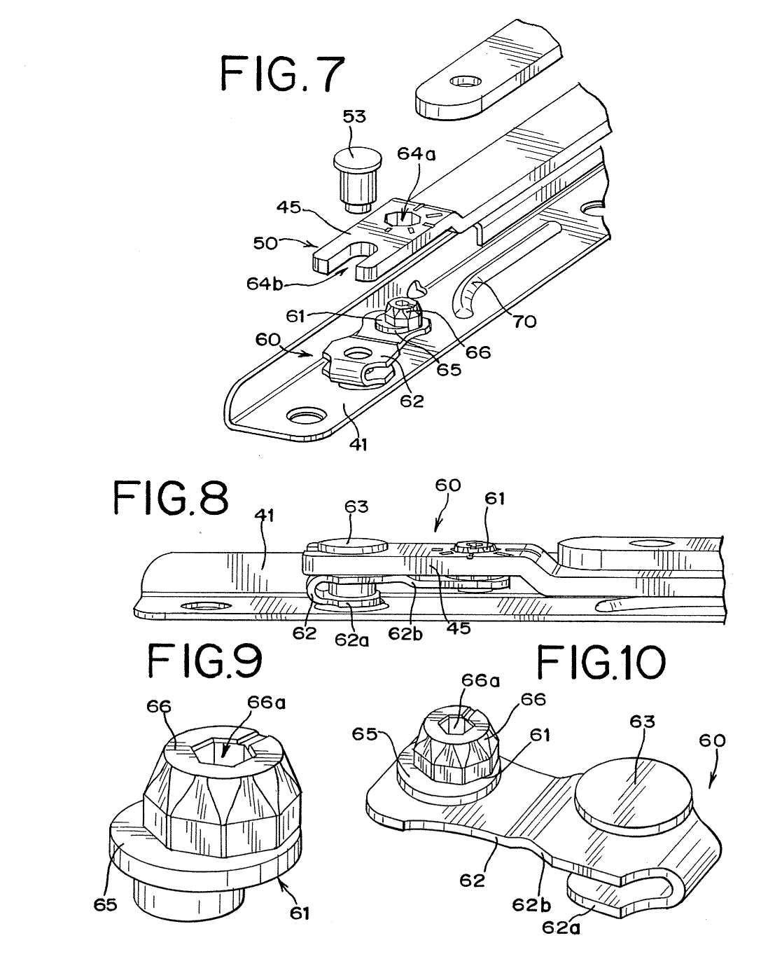

FIGS. 2-10 show a hinge assembly 40 suitable for use with a casement window assembly 10 as shown in FIGS. 1-1B. The hinge assembly 40 includes a frame 41, a hinge track 42 extending along the frame 41, a shoe 43 slidably mounted on the track 42, a sash arm 44 pivotably coupled to the shoe 43, and a swivel arm 45 pivotably coupled to the frame 41 and the sash arm 44. The swivel arm connection 47 contains an adjustment mechanism 60 for adjusting the hinge assembly 40. The hinge assembly 40 is generally connected between one of the horizontal jambs 27,28 of the jamb frame assembly 14 and one of the horizontal rails 23,24 of the window assembly 16. As shown in FIG. 1A, the window assembly 10 includes two hinge assemblies 40, located at the top and bottom of the window frame 14, respectively. The sash arm 44 is connected to one of the horizontal rails 23,24 of the window 16 in a lengthwise manner, and the swivel arm 45 is pivotably connected to the sash arm 44, creating an operable connection between the swivel arm 45 and the window 16. The frame 41, the track 42, the sash arm 44, the shoe 43, the swivel arm 45, and some components of the adjustment mechanism are preferably made of stainless steel or another metal, but may be made from another suitable material.

The frame 41 illustrated is an L-shaped metal beam or rail, having two legs 41a,41b arranged at substantially right angles, and is adapted to be fastened to one of the horizontal jambs 27,28 of the jamb frame assembly 14. In the embodiment shown, the horizontal leg 41a is longer than the vertical leg 41b. The frame 41 generally has several fastener holes 46 for attachment to the jamb 27,28 or other components of the hinge assembly 40. In other embodiments, the frame 41 can be differently shaped, for example, having a C-shape or a T-shape. Further, the frame 41 may be arranged differently for use with a different type of window assembly 10. For example, the frame 41 may be adapted to be attached to other portions of a window assembly 10, such as the vertical jambs 29,30, if the window 16 swings vertically rather than horizontally. It is understood that the use of the terms “horizontal” and “vertical” are made for reference purposes, and that these orientations may be different when mounted in a vertically-swinging or otherwise different window assembly.

The track 42 runs along a portion of the length of the frame 41, and, in the embodiment shown, is defined by the face of the horizontal leg 41a of the frame 41 and a channel 48 at the tip of the vertical leg 41b. The track 42 may have a stop (not shown) at one or both ends of the track to prevent the shoe 43 from moving out of the track 42. In other embodiments, the track 42 may be differently defined or arranged, such as when the frame 41 or the orientation of the window assembly 10 is arranged differently.

The shoe 43 is slidably mounted on the track 42. In the embodiment shown in FIG. 6, the shoe 43 has a flange portion 52 that is received in the channel 48 of the track 42, allowing the shoe 43 to slide back and forth within the track 42. This arrangement of the shoe 43 and the track 42 is generally known in the art. However, in other embodiments, the shoe 43 and the track 42 may be arranged in a different type of cooperative sliding engagement. The shoe 43 preferably has a rivet 53 to connect the shoe 43 to the sash arm 44, which extends through holes 46 in the shoe 43 and the sash arm 44. The rivet 53 is fixedly attached to the sash arm 44 and is pivotable with respect to the shoe 43. Thus, as the shoe 42 moves in the track 42, the sash arm 44 and the rivet 53 pivot with respect to the shoe 43.

Generally, the frame 41 has means for assisting insertion of the flange 52 of the shoe 43 into the channel 48 to mount the shoe 43 on the track 42. In the embodiment shown in FIGS. 2-10, this means is embodied by a guide 70 positioned at the end of the track 42 proximate the swivel arm connection 47, the structure and operation of which are described below.

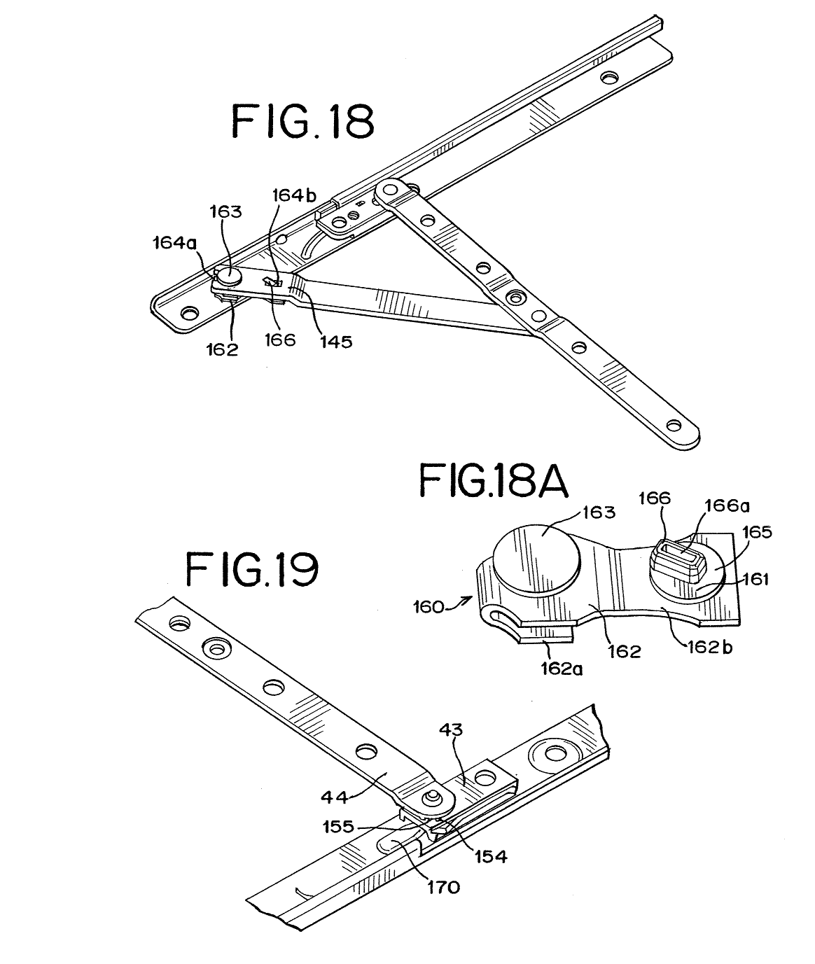

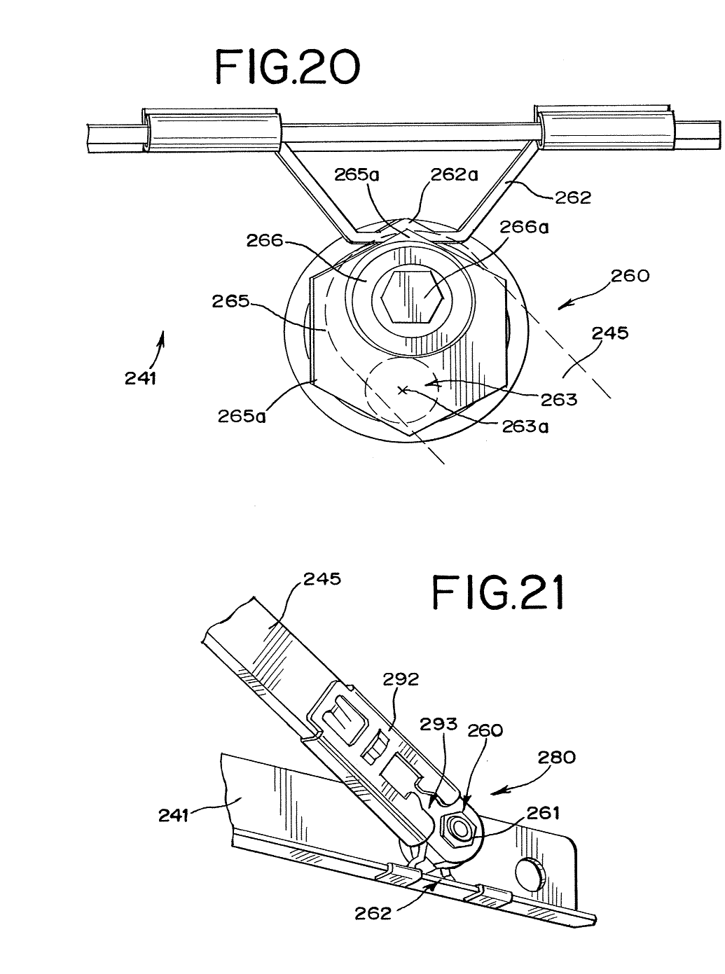

The shoe 43 also has means for limiting pivoting of the sash arm 44 relative to the shoe 43. In the embodiment shown in FIGS. 2-3, and illustrated in more detail in FIG. 5, the rivet 53 has a projection 54 near the base and the underside of the shoe 43 has a partially-circumferential groove 55 that receives the projection 54 when the rivet 53 is connected to the shoe 43. As the rivet 53 pivots, the projection 54 moves through the groove 55, and the ends of the groove 55 limit the range of movement of the projection 54, consequently limiting the range of rotation of the rivet 53. Accordingly, the length of the groove 55 determines the limits over which the sash arm 44 can pivot. Typically, around 90° of pivoting is necessary for operation of the hinge assembly 40. However, the groove 55 provided allows for 135° of pivoting of the sash arm 44, in case a greater range is needed for assembly. In another embodiment, the groove 55 and the projection 54 may be transposed between the shoe 43 and the rivet 53. In a further embodiment, illustrated in FIG. 19, the means for limiting pivoting of the sash arm 44 relative to the shoe 43 may be embodied in cooperative structure between the shoe 43 and the sash arm 44. As shown in FIG. 19, the shoe 43 has a projection 154 and the end 49 of the sash arm 44 has a groove 155. As the sash arm 44 pivots with respect to the shoe 43, the projection 154 limits the range of pivoting by engaging the ends of the groove 155 on the sash arm 44.

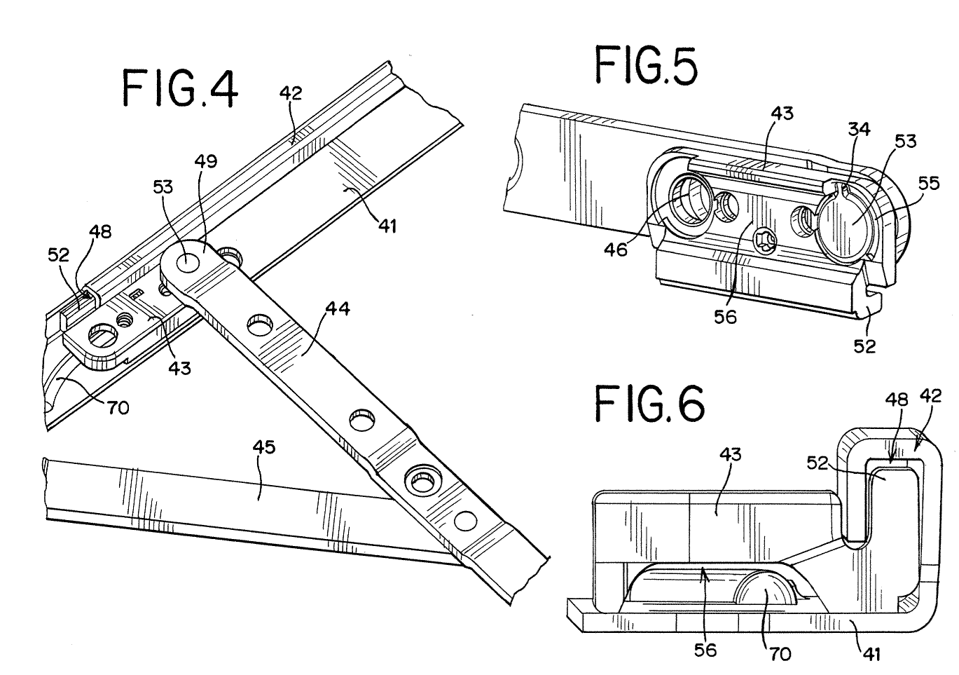

The guide 70 is positioned on the longer leg 41a of the frame 41 proximate the end of the track 42, and functions both to guide insertion of the shoe 43 into the track 42 and to prevent the shoe 43 from being pulled out of the track 42. As shown in FIGS. 3-4, the guide 70 is an curved, embossed ridge 70 that leads toward the end of the track 42 and partially down the length of the track 42. The shoe 43 has a slot or recess 56 on the underside that can receive the ridge 70. To insert the shoe 43 into the track 42, the shoe 43 is placed so the ridge 70 is received in the recess 56, and the shoe 43 is then slid forward toward the track 42. As the shoe 43 slides forward, the downward curve of the ridge 70 guides the shoe 43 into the proper position for entering the track 42. Additionally, if the shoe 43 is attempted to be pulled from the track 42 in a direction normal to the track 42, the contact between the bottom of the shoe 43 and the ridge 70 will cause the shoe 43 to twist, forcing the flange portion 52 more tightly into the channel 48, resisting separation. In another embodiment, illustrated in FIG. 19, the guide 170 is a shorter, wider, embossed plateau 170 that is tapered at the end to guide the shoe 43 into the track 42.

The sash arm 44 is pivotably coupled at one end 49 to the shoe 43, and is connected along its length to one of the horizontal rails 23,24 of the inner window assembly 16, and has several fastener holes 46 for this purpose. In the hinge assembly 40 shown in FIGS. 2 and 3, the sash arm 44 is adapted to be connected to the bottom horizontal rail 24. Because the sash arm 44 is pivotable and connected to the sliding shoe 43, the pivotable end 49 of the sash arm 44 can simultaneously slide and pivot to allow opening and closing of the window 16. In other embodiments, the sash arm 44 may be differently configured.

The swivel arm 45 is pivotably coupled at one end 50 to the frame 41 and pivotably coupled at the other end 51 to the sash arm 44 and to one of the horizontal rails 23, 24 of the window 16 by a rivet 51a. The adjustment mechanism 60 forms an adjustable, pivotable connection 47 between the swivel arm 45 and the frame 41. The swivel arm 45 provides an “anchor” for the sash arm 44, because the pivotable connection 47 between the swivel arm and the adjustment mechanism 60 is fixed once the adjustment mechanism 60 is set. As the window 16 opens and closes, the swivel arm 45 pivots with the sash arm 44, but does not slide, thus supporting and anchoring the sash arm 44. In other embodiments, the swivel arm 45 may be differently configured.

The adjustment mechanism 60 is located at the connection 47 between the swivel arm 45 and the frame 41. One exemplary embodiment of the adjustment mechanism 60 is shown in FIGS. 2-3 and is illustrated in more detail in FIGS. 7-10. The adjustment mechanism 60 generally includes a rotatable, eccentric adjuster 61 connected to a spring member 62 and a pin 63 that pivotably connects the spring member 62 to the frame 41. The adjuster 61 has a rotatable base 65 that is rotatably coupled to the spring 62 and a knob or projection 66 that extends from the base 65 in an eccentric manner, so that rotation of the base 65 causes lateral movement of the projection 66. The projection 66 further has a hex-opening 66a that is adapted to receive an adjustment tool, such as an Allen wrench. As illustrated in FIGS. 8 and 10, the spring member 62 is substantially C-shaped, having a lower leg 62a and an upper leg 62b. The lower leg 62a is pivotably coupled to the hinge frame 41 and the upper leg 62b has the pin 63 and the adjuster 61 extending therefrom in the assembled condition. The end 50 of the swivel arm 45 has a slot 64a that receives the pin 63 in a pivotable arrangement and an aperture 64b that receives the projection 66 of the adjuster 61, as shown in FIGS. 7-8. In the embodiment illustrated, the slot 64a extends to the tip of the swivel arm 45, forming a forked tip. The projection 66 and the aperture 64b are cooperatively dimensioned, both having hexagonal shapes, to create a fixed, interlocking connection. As the window 16 is opened and closed, the swivel arm 45 pivots at the connection 47 about the pin 63, with the end 50 of the swivel arm 45 and the spring 62 both pivoting together.

To connect the swivel arm 45 to the adjustment mechanism 60, the end of the swivel arm 45 can be pushed so that the pin 63 is forced into the slot 64a, and the spring 62 will flex downward with contact between the adjuster 61 and the bottom of the swivel arm 45. Once the adjuster 61 and the aperture 64b are aligned, the spring 62 will snap the adjuster 61 back upward through the aperture 64b, completing the connection. Disconnecting the swivel arm 45 from the adjustment mechanism 60 can be done in a similar manner. A force is applied to the spring 62, causing the spring 62 to flex downward to move the projection 66 out of position to be received within the aperture 64b. Once this is accomplished, the swivel arm 45 can be pulled to disengage the pin 63 from the slot 64a.

To adjust the adjustment mechanism 60, the spring 62 is pushed downward to release the interlocking connection between the projection 66 and the aperture 64b, so the adjuster 61 is free to rotate. The adjuster 61 is then rotated, possibly using a tool received in the hex-opening 66a, and the eccentric nature of the adjuster 61 causes the projection 66 to move laterally. When the projection 66 is in the proper position, the spring 62 is released, forcing the projection 66 back through the aperture 64b, re-connecting the swivel arm 45 and the adjustment mechanism 60.

The frame 41, the shoe 43, the sash arm 44, and the swivel arm 45 are connected as shown in FIG. 2. The frame 41 is fixedly mounted to one of the jambs 27, 28. The shoe 43 is slidably mounted in the track 42 and slides back and forth along the track 42. The sash arm 44 is pivotably coupled to the shoe 43, forming a pivotable connection, and is capable of sliding and pivoting motion. Additionally, the sash arm 44 is mounted to one of the rails 23, 24 of the window 16. The swivel arm 45 is pivotably coupled to the sash arm 44 and operably coupled to the window 16, forming a pivotable connection, and is also coupled via a pivotable connection 47 to the adjustment mechanism 60, providing an anchor for the sash arm 44. As the window 16 is opened, the shoe 43 slides along the track 42 to the right in FIG. 2, the pivotable connection between the sash arm 44 and swivel arm 45 moves away from the frame 41, and the sash arm 44 and swivel arm 45 pivot accordingly. Conversely, as the window 16 is closed, the shoe 43 slides along the track 42 to the left in FIG. 2, the pivotable connection between the sash arm 44 and swivel arm 45 moves toward the frame 41, and the sash arm 44 and swivel arm 45 pivot accordingly. The hinge assembly 40 can be adjusted by the adjustment mechanism 60 by moving the anchor point, i.e. the connection point 47 between the adjustment mechanism 60 and the swivel arm 45.

In another embodiment, shown in FIGS. 18 and 18A, the adjustment mechanism 160 is similar in structure to the adjustment mechanism described above, having an adjuster 161, a spring 162, and a pin 163 pivotably connecting the spring 162 to the frame 41. The spring 162 and the pin 163 are similar in structure and function to the spring 62 and pin 63 described above. However, the adjuster 161 and the aperture 164b are designed differently than those described above. The adjuster 161 has an eccentric projection 166, but the projection 166 is rectangular rather than hexagonal. The aperture 164b is shaped to accept the projection 166 in three different positions: one angled position and two positions where the projection 166 is parallel to the length of the swivel arm 145, both 180° apart from each other. Adjustment and connection of the swivel arm 145 is accomplished in the same manner described above.

In another embodiment, shown in FIG. 20, the adjustment mechanism 260 has an eccentric rivet 261 to which the end 250 of the swivel arm 245 is pivotably attached. The rivet 261 has a hexagonal base 265 and a mounting structure 263 mounting the rivet 261 to the frame 241, defining an axis of rotation 263a. The adjustment mechanism 260 also includes a retaining member 262 that engages the base 265 to prevent undesired rotation of the rivet 261. Like the eccentric adjuster 61, the eccentric rivet 261 has a projection 266 that is eccentric to the axis of rotation 263a of the base 265, such that rotation of the base 265 causes lateral movement of the projection 266, permitting adjustment of the swivel arm 245. The retaining member 262 has a notch 262a that receives one of the points 265a of the hexagonal base 265, resisting rotation of the rivet 261. To rotate the rivet 261, the retaining member 262 is moved away from the base 265, allowing the rivet 261 to pivot. Thus, the retaining member 262 is moveable between a first position, where the retaining member 262 engages the base 265 of the adjuster 261 to prevent rotation of the adjuster 261 such that one of the points 265a is received in the notch 262a, and a second position, wherein the retaining member 262 does not engage the base 265 of the adjuster 261 to prevent rotation of the adjuster 261. In the embodiment shown, the retaining member 262 is pivotably connected to the hinge frame 241, and can pivot between the first position and the second position, such as by manual manipulation.

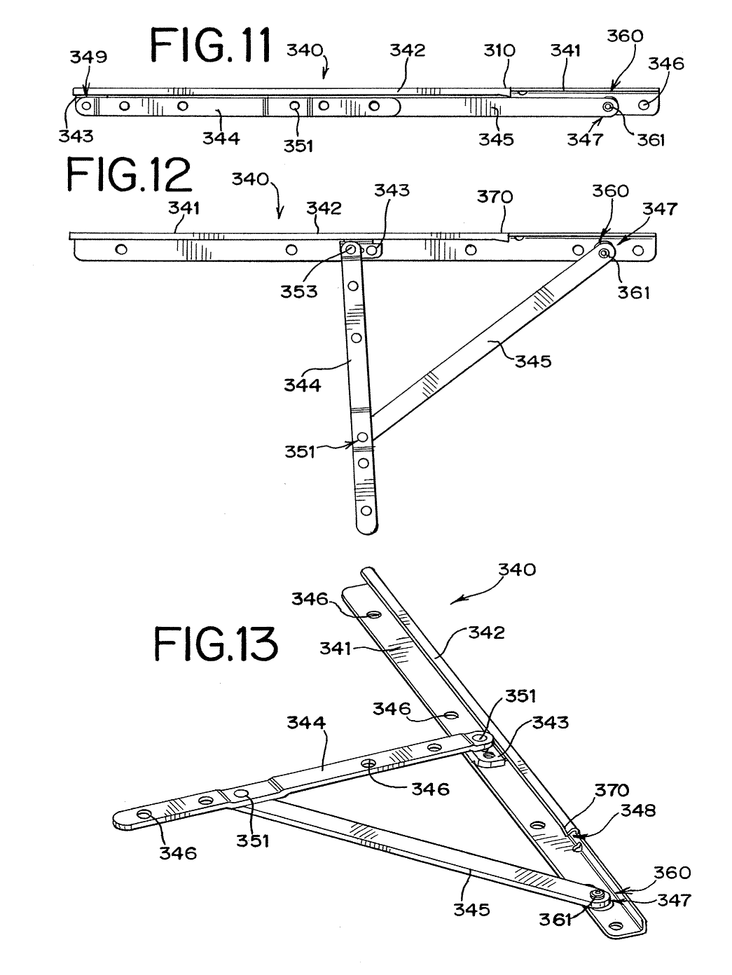

FIG. 21 illustrates the hinge assembly 240 of FIG. 20, also including an exemplary embodiment of a rivet or pin connection assembly 280. The connection assembly 280 can be used with the hinge assembly 340 described herein and shown in FIGS. 11-17, or another hinge assembly, such as the hinge assembly 40 shown in FIGS. 2-10. Generally, the connection assembly includes a snap member 292 having a notch 293 therein. The snap member 292 is slidably disposed on the swivel arm 245. After the swivel arm 245 is connected to the adjuster 261, the snap member 292 is slid toward the adjuster 261 and snapped onto the adjuster 261 so that a portion of the projection 266 is received within the notch 293 and is engaged by the snap member 292. This engagement secures the connection between the swivel arm 245 and the adjuster 261. The projection 266 may have a recess (not shown) therein that receives a portion of the snap member 292 to further increase the security of the connection. When the swivel arm 245 is to be removed, the snap member 292 can simply be slid backwards away from the adjuster 261 to release the adjuster 261.

FIGS. 11-17 show another embodiment of a hinge assembly 340 suitable for use with a casement window assembly 10 as shown in FIGS. 1-1B. Like the hinge assembly 40 described above, the hinge assembly 340 includes a frame 341, a hinge track 342 extending along the frame 341, a shoe 343 slidably mounted on the track 342, a sash arm 344 pivotably coupled to the shoe 343, and a swivel arm 345 pivotably coupled to the frame 341 and the sash arm 344. The swivel arm connection 347 contains an adjustment mechanism 360 for adjusting the hinge assembly 340. These components are illustrated in FIGS. 11-14. The hinge assembly 340 is generally connected between one of the horizontal jambs 27,28 of the jamb frame assembly 14 and one of the horizontal rails 23,24 of the window assembly 16. The sash arm 344 is connected to one of the horizontal rails 23,24 of the window 16 in a lengthwise manner, and the swivel arm 345 is pivotably connected to the sash arm 344, creating an operable connection between the swivel arm 345 and the window 16. The hinge assembly 340 shown in FIGS. 11-17 contains many components similar to those shown and described above with respect to the hinge assembly 40 shown in FIGS. 2-10. Accordingly, similar components in the hinge assembly 340 will be numbered similarly to the corresponding components in the hinge assembly 40 of FIGS. 2-10, using the “300” series of reference numerals. Additionally, the general components hinge assembly 340 will not be described in great detail, and several specific features of the hinge assembly 340 are described below.

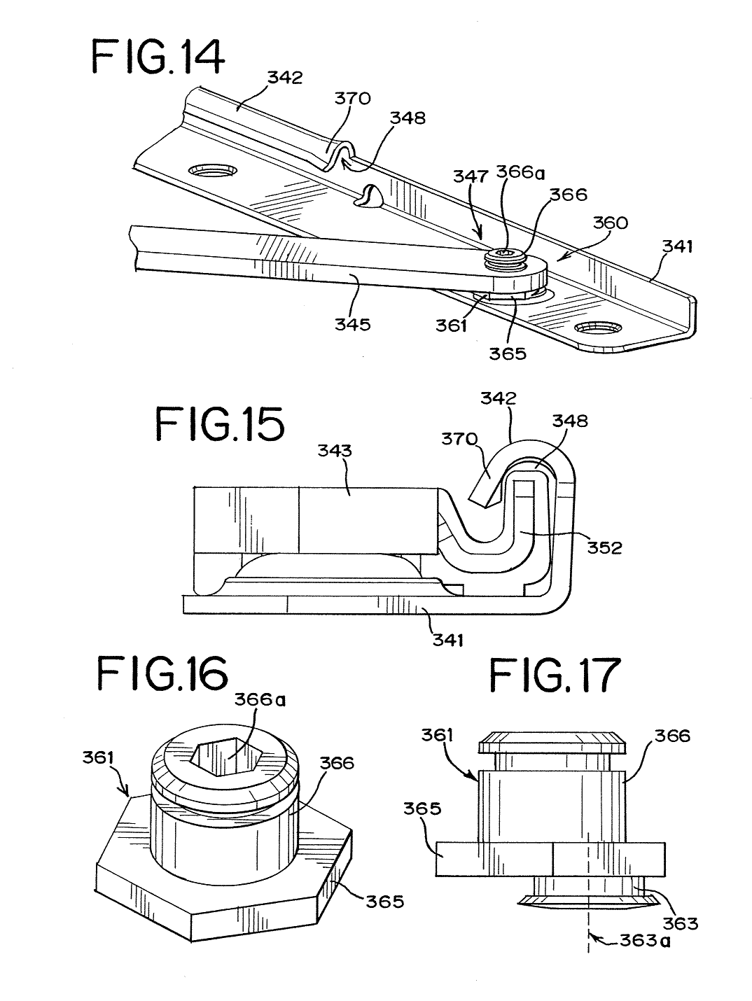

The adjustment mechanism 360 of the hinge assembly 340 shown in FIGS. 11-17 contains an eccentric adjuster 361, shown in greater detail in FIGS. 14, 16, and 17. The adjuster 361 has a hexagonal base 365 and a mounting structure 363 mounting the adjuster 361 to the frame 341, defining an axis of rotation 363a. In one embodiment, the adjuster 361 is a rivet, and is riveted to the frame 341. The adjuster 361 also has a projection 366 that is eccentric to the axis of rotation 363a, as shown in FIG. 17. The projection 366 further has a hex-opening 366a that is adapted to receive an adjustment tool, such as an Allen wrench. The swivel arm 345 is pivotably connected to the projection 366 to form a swivel arm connection 347. Rotation of the eccentric adjuster 361 about the axis of rotation 363a will move the projection 366 laterally, thereby adjusting the position of the swivel arm connection 347 and adjusting the position of the window 16 within the window frame 14.

The hinge assembly 340 shown in FIGS. 11-17 also has means for assisting insertion of the flange 352 of the shoe 343 into the channel 348 to mount the shoe 343 on the track 342. In this embodiment, the means is embodied by a flared portion 370 on the end of the channel 348. The flared portion 370 has a width greater than the width of the channel 48 along the majority of the length thereof. The flared portion 370 also has an upward flare on the top surface of the channel, and thus also has a height greater than the height of the channel 48 along the majority of the length thereof. In mounting the shoe 343 on the track 342, the shoe 343 is placed near the end of the track 343, proximate the flared portion 370. The shoe 343 is then pushed toward the track 342 such that the flange 352 enters the flared portion 370. The greater width and height of the flared portion 370 facilitates entry of the flange 352 into the channel 348, because extreme precision is not required for the connection. Thus, the shoe 343 can be slidably mounted on the track 342 with greater ease. FIG. 15 illustrates the shoe 343 having the flange 352 inserted into the flared portion 370 to be received within the channel 348. Additionally, the flared portion 370 may have a length that is smaller than the length of the flange 352, so that the flange 352 enters the main body of the channel 348 more quickly.

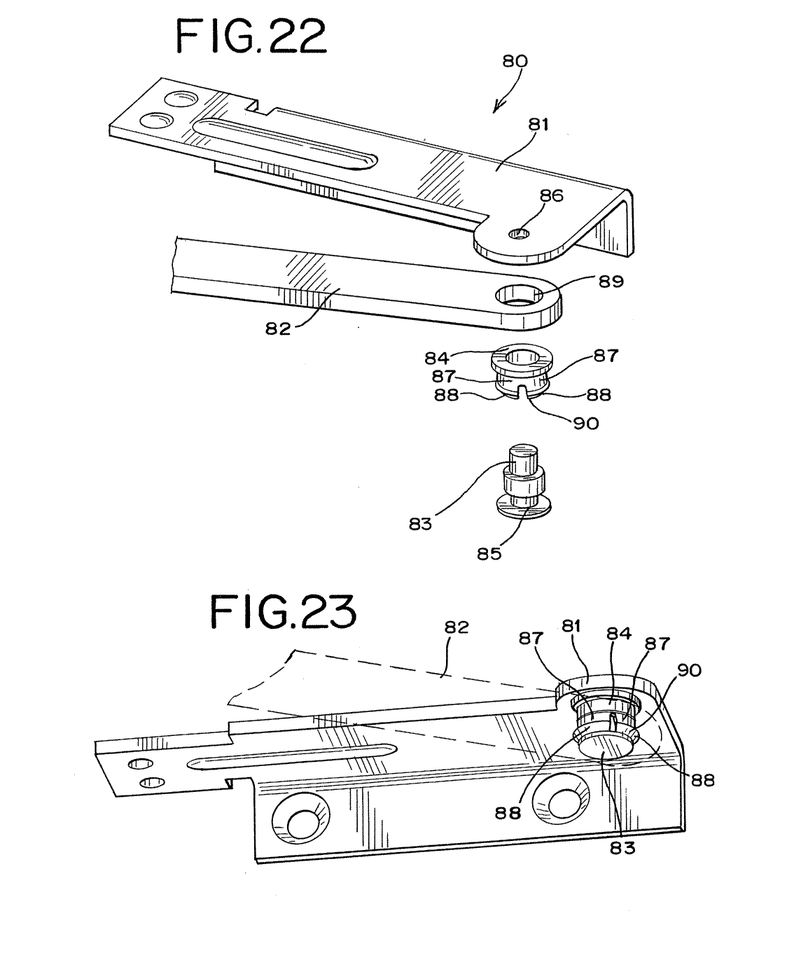

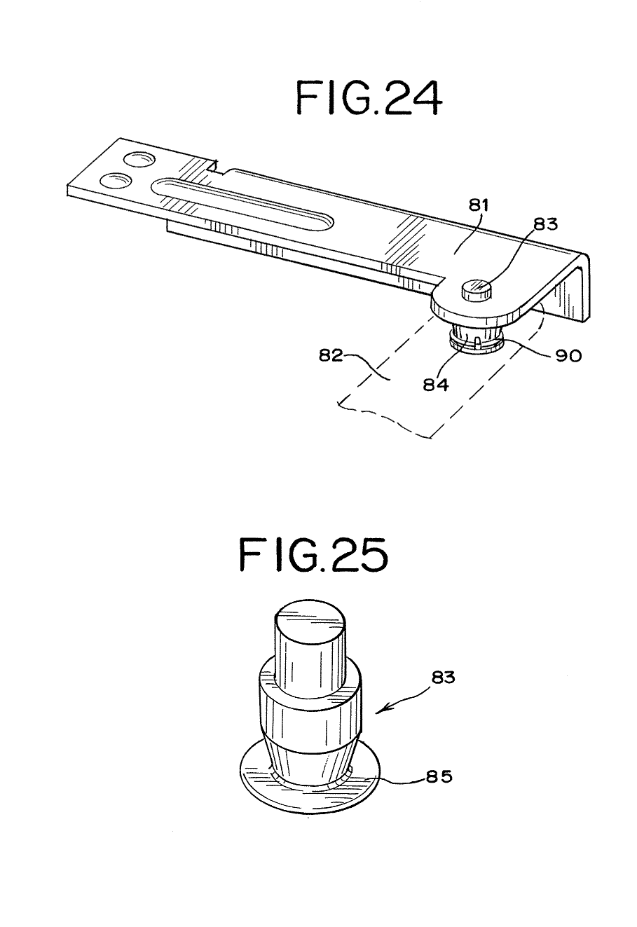

FIGS. 22-24 illustrate another exemplary embodiment of a rivet or pin connection assembly 80 that is suitable for establishing a secure, snap-on pivotable connection. The connection assembly 80 can be used to connect components of the hinge assembly 40, such as pivotably connecting the arms 44,45 to each other or to the frame 41, as well as pivotably connecting components of an operating mechanism 32, such as connecting operating arms 37 to a track or sash bracket. The connection assembly 80 includes a base member 81, a pivoting member 82, a rivet 83, and a flexible bushing 84. The base member 81 may be an arm, such as an operating arm or the hinge arms 44,45 described above, or a fixed member such as a hinge frame 41, track, or sash bracket. The base member 81 shown in FIGS. 22-24 is a sash bracket. The pivoting member 82 shown is pivotable with respect to the base member 81, and is generally a pivoting arm, such as an operator arm 37.

In assembling the connection assembly 80, the rivet 83 is inserted through the bushing 84 and upward through an aperture 86 in the base member 81. The tip of the rivet 83 extending through the base member 81 is then fastened to the base member 81 so the rivet 83 cannot slip back through the hole 86. The rivet 83 has a flange 85 on one end that is generally the same diameter as the tip of the bushing 84, and flange 85 traps the bushing 84 between the flange 85 and the base member 81. The bushing 84 generally has a flange 90 and a tapered portion 88 tapered outwardly from the flange 85, as well as a plurality of flexible fingers 87, each of which have tapered portions 88 adjacent the flange 90. The pivoting member 82 is attached to the rivet 83 by inserting the rivet 83 and bushing 84 through an aperture 89 in the pivoting member 82. As the inner surface of the aperture 89 contacts the tapered portion 88, the flexible fingers 87 of the bushing 84 flex inwardly to permit the pivoting member 82 to pass the flange 90. When the pivoting member 82 passes the flange 90, the flexible fingers 87 snap back outwardly. The outwardly-flexed flange 90 has a width that is greater than the width of the aperture 89, and thus the flange 90 secures the pivoting member 82 to the bushing 84 to form the pivotable connection. Thus, connecting the pivoting member 82 to the base member 81 can be done by a simple snap-on connection.

While the specific embodiments have been illustrated and described, numerous modifications come to mind without significantly departing from the spirit of the invention, and the scope of protection is only limited by the scope of the accompanying Claims.

What is claimed is:

1. A hinge assembly for a casement window assembly having a window hingedly mounted within a window frame, the hinge assembly comprising:
a hinge frame adapted to be mounted on the window frame, the hinge frame having a track comprising an elongated channel;
a shoe slidably mounted on the track such that a portion of the shoe is received in the channel;
a sash arm pivotably coupled at one end to the shoe and adapted to be attached to the window; and
means disposed on the hinge frame for assisting insertion of the portion of the shoe into the channel to mount the shoe on the track.

2. The hinge assembly of claim 1, wherein the means for assisting insertion of the portion of the shoe into the channel comprises a flared portion on an end of the channel.

3. The hinge assembly of claim 2, wherein the flared portion has a width greater than a width of the channel along a majority of the length thereof.

4. The hinge assembly of claim 2, wherein the flared portion has a height greater than a height of the channel along a majority of the length thereof.

5. The hinge assembly of claim 2, wherein the portion of the shoe inserted into the channel comprises a flange, and the flared portion has a length that is smaller than a length of the flange.

6. The hinge assembly of claim 1, wherein the means for assisting insertion of the portion of the shoe into the channel comprises an embossed guide on the hinge frame adjacent an end of the channel.

7. The hinge assembly of claim 4, wherein the shoe is mounted on the track by sliding the shoe along the guide and into position for insertion of the portion into the channel.

8. The hinge assembly of claim 4, wherein the guide is an elongated, curved ridge embossed on the hinge frame.

9. The hinge assembly of claim 4, wherein the guide is a tapered plateau embossed on the hinge frame.

10. A hinge assembly for a casement window assembly having a hinged window pivotably mounted within a window frame, the hinge assembly comprising:
a hinge frame adapted to be mounted on the window frame;
a hinge arm pivotably coupled at a first end to the hinge frame and adapted to be operatively coupled at a second end to the window, the first end of the hinge arm having a slot proximate a tip thereof and an aperture spaced from the slot; and
a mounting structure for pivotably coupling the hinge arm to the hinge frame, comprising:
a spring member pivotably coupled to the hinge frame,
a pin connected to the spring member, the pin received in the slot at the first end of the hinge arm,
an adjuster rotatably coupled to the resilient spring member and coupled to the hinge arm such that a projection of the adjuster is received within the aperture of the hinge arm, wherein rotation of the adjuster changes the position of the projection with respect to the pin, thereby changing the position of the hinge arm with respect to the pin, wherein the hinge arm is connectable to and disconnectable from the mounting structure by flexing the spring member to move the projection of the adjuster out of position to be received within the aperture of the hinge arm.

11. The hinge assembly of claim 10, wherein the spring member is substantially C-shaped, having a lower leg and an upper leg, the lower leg being pivotably coupled to the hinge frame and the upper leg having the pin and the adjuster extending therefrom.

12. The hinge assembly of claim 10, wherein the pin extends through the spring member and pivotably couples the spring member to the hinge frame.

13. The hinge assembly of claim 10, wherein the slot extends to a tip of the first end of the hinge arm, forming a forked tip.

14. The hinge assembly of claim 10, wherein the projection of the adjuster is eccentric with respect to an axis of rotation of the adjuster.

15. The hinge assembly of claim 10, wherein the adjuster and the aperture have complementarily-shaped interlocking surfaces, and wherein the spring member is flexed to move the projection out of position to be received within the aperture before the adjuster is rotated to adjust the position of the projection.

16. The hinge assembly of claim 10, wherein the projection of the adjuster and the aperture are hex-shaped.

17. An adjustment mechanism for a casement window assembly having a hinged window pivotably mounted within a window frame by a hinge assembly, the hinge assembly having one or more pivotable arms operably connected to the window, the adjustment mechanism comprising:
an adjuster adapted to be mounted on the hinge assembly, the adjuster comprising a base having an outer surface with a plurality of points thereon, a mounting structure connected to the base and adapted to be rotatably mounted on the hinge assembly to define an axis of rotation of the adjuster, and a projection adapted to be pivotably connected to one of the arms of the hinge assembly, the projection being eccentric to the axis of rotation such that rotation of the adjuster is adapted to move the projection with respect to the hinge assembly; and
a retaining member adapted to be mounted on the hinge assembly, the retaining member having a notch therein, wherein the retaining member is moveable between a first position, wherein the retaining member engages the base of the adjuster to prevent rotation of the adjuster such that one of the points is received in the notch, and a second position, wherein the retaining member does not engage the base of the adjuster to prevent rotation of the adjuster.

18. The adjustment mechanism of claim 17, wherein the base is hex-shaped.

19. The adjustment mechanism of claim 17, wherein the retaining member is adapted to be pivotably coupled to the hinge assembly, and the retaining member moves between the first and second positions by pivoting.

20. A hinge assembly for a casement window assembly having a window hingedly mounted within a window frame, the hinge assembly comprising:
a hinge frame adapted to be mounted on the window frame, the hinge frame having a track thereon;
a shoe slidably mounted on the track;
a sash arm pivotably coupled at one end to the shoe and adapted to be attached to the window; and
means for limiting a range of pivoting of the sash arm with respect to the shoe.

21. The hinge assembly of claim 20, wherein the means for limiting the range of pivoting of the sash arm with respect to the shoe is formed by engagement between the shoe and the sash arm.

22. The hinge assembly of claim 21, wherein the means for limiting the range of pivoting of the sash arm with respect to the shoe comprises a groove on the end of the sash arm and a projection on the shoe, wherein the projection is received in the groove, and engagement between the projection and opposed ends of the groove limit the range of pivoting of the sash arm.

23. The hinge assembly of claim 20, further comprising a rivet pivotably connecting the sash arm to the shoe, wherein the means for limiting the range of pivoting of the sash arm with respect to the shoe is formed by engagement between the shoe and the rivet.

24. The hinge assembly of claim 23, wherein the means for limiting the range of pivoting of the sash arm with respect to the shoe comprises a groove on the shoe and a projection on the rivet, wherein the projection is received in the groove, and engagement between the projection and opposed ends of the groove limit the range of pivoting of the sash arm.

25. A snap-on connection assembly for a casement window assembly having a hinged window disposed within a window frame, the connection assembly comprising:
a first member of the casement window assembly, having a first aperture therein;
a second member of the casement window assembly, having a second aperture therein;
a rivet extending through the first aperture and connected to the first member; and
a flexible, resilient bushing disposed around the rivet, the bushing having a flange and a tapered portion adjacent the flange,
wherein the second member is pivotably connected to the first member by inserting the rivet and the bushing into the second aperture, wherein an inner surface of the second aperture contacts the tapered portion to flex the bushing inwardly to permit the second member to pass the flange, and wherein when the second member passes the flange, the bushing flexes outwardly, the outwardly-flexed flange having a width that is greater than a width of the second aperture, securing the second member to the bushing to form the pivotable connection.

26. The snap-on connection assembly of claim 25, wherein the bushing comprises a plurality of flexible fingers each having a flange and a tapered portion thereon, wherein the flexible fingers flex inwardly to permit the second member to pass each respective flange.

27. The snap-on connection assembly of claim 25, wherein the rivet has a first end connected to the first member and a second end having a flange thereon, the flange engaging the bushing to secure the bushing to the rivet.

28. The snap-on connection assembly of claim 25, wherein the first member is a sash bracket adapted to be mounted to the window and the second member is an arm pivotably connected to the sash bracket.

29. The snap-on connection assembly of claim 25, wherein the rivet is rigidly connected to the first member.
